(19) United States
(12) Patent Application Publication
(10) Pub. No.: US 2004/0249621 A1
(43) Pub. Date: Dec. 9, 2004

(54) Network design utilizing integrated planning and configuration

(76) Inventors: Mansoor Ali Khan Alicherry, Scotch Plains, NJ (US); Sadanand M. Gogate, Monmouth Junction, NJ (US); Harsha S. Nagesh, New Providence, NJ (US); Chitra A. Phadke, Basking Ridge, NJ (US); Viswanath Poosala, Basking Ridge, NJ (US)

Correspondence Address: Ryan, Mason & Lewis, LLP, 90 Forest Avenue, Locust Valley, NY, 11560, US

(21) Appl. No.: 10/426,500

(22) Filed: Apr. 30, 2003

(51) Int. Cl. G06F 13/12; G06F 9/44; G06F 13/10

(52) U.S. Cl. 703/21

(57) ABSTRACT

Techniques for designing networks. The techniques integrate the planning and configuration steps of the design process so that an optimal network may be designed. An automated technique for designing a network may comprise the following steps. First, a set of nodes and a set of links with which network equipment may be deployed, and one or more traffic demands are obtained. Then, a network is computed by determining one or more routes for the one or more traffic demands while querying at least a portion of the network equipment to determine a cost for using said equipment to route the one or more traffic demands such that said cost is considered when determining the one or more routes. The network equipment may be queried via one or more application programming interfaces. By obtaining the costs associated with routing a demand directly from the equipment that would be used to support the route, the techniques of the invention provide an optimal network design, and yield a configured network at the end of the process.

### CROSS REFERENCE TO RELATED APPLICATION

This application relates to the U.S. patent application identified as attorney docket no. Alicherry 4-3-4-4-19, entitled “Network Design Utilizing Network Management Routing Algorithm,” filed concurrently herewith and commonly assigned, the disclosure of which is incorporated by reference herein.

### FIELD OF THE INVENTION

The present invention relates to techniques for designing networks and, more particularly, to network design techniques utilizing integrated planning and configuration.

### BACKGROUND OF THE INVENTION

Designing a network, such as a core optical network, generally involves two main tasks. The first task is to compute the cost-optimal topology of the network. In the optical network context, this task may include determining which set of geographic locations (e.g., cities) in the network should be connected to each other with optical transmission systems (OLS). The second task is to configure each of these OLS with the proper equipment in their cost-optimal configurations.

The first task is generally referred to as network planning, while the second task is generally referred to as network configuration. In the conventional design approach, these tasks are performed sequentially, i.e., first the planning step is performed, and then separate from the planning step, the configuration step is performed at a later time. One of the main reasons for this conventional approach is that modeling equipment is complex and the complexity of the planning process increases many fold when coupled with configuration issues. However, such decoupling can result in generating sub-optimal networks which would be a more expensive solution in terms of dollar cost.

Design algorithms, such as the Spider algorithm described in R. D. Davis et al., “Spider: A Simple and Flexible Tool for Design and Provisioning of Protected Lightpaths in Optical Networks,” Bell Labs Technical Journal, January-June 2001, the disclosure of which is incorporated by reference herein, model equipment in a simplistic dollar cost of routing a traffic demand on a link (e.g., between two cities). That is, such equipment is modeled by a single number, namely, cost per mile per channel.

However, optical line systems include complicated equipment. They do not have a uniform cost per channel as they need different kinds of additional equipment packs such as Raman pumps, bays, shelves, etc., as the number of channels increases. Further, such systems rarely have a uniform cost spread over distance. This is fundamentally due to the fact that these systems are deployed on links which have fibers with different non-linear effects. It is common to have several kinds of amplifiers deployed in special locations, depending on the loss for which an amplifier has to compensate on the fiber. In addition, optical signals have to be regenerated at suitable distances depending on fiber quality. Simplistic algorithms which are agnostic to network realities end up computing inaccurate network designs which may not work in the field.

Furthermore, some conventional design algorithms assume that the cost of routing wavelengths associated with a demand on all links is the same and is some constant cost. For example, some approaches consider a step function kind of cost, which assumes that the cost of adding wavelengths 0 to 10 to be some constant, 10 to 20 to be some other constant, and so on. This approach fails to capture the realistic costs of building the network as these costs may be different for different links in the network. A network designed using this approach, at the end of routing all the demands, still needs to be configured to find out the exact equipment needed to support all the wavelengths flowing through this link. Since, only approximate costs are used while routing the demands during the planning phase, in the end, when one tries to configure the network, each link may end up with equipment that has a much higher cost. Thus, the optimality of the design is lost.

### SUMMARY OF THE INVENTION

The present invention provides automated techniques for designing networks. The techniques integrate the planning and configuration steps of the design process so that an optimal network may be designed.

In one aspect of the invention, an automated technique for designing a network comprises the following steps. First, a set of nodes and a set of links (e.g., an initial topology) with which network equipment may be deployed, and one or more traffic demands are obtained. Then, a network is computed by determining one or more routes for the one or more traffic demands while querying at least a portion of the network equipment to determine a cost for using said equipment to route the one or more traffic demands such that said cost is considered when determining the one or more routes. The network equipment may be queried via at least one application programming interface.

Advantageously, by obtaining the costs associated with routing a demand directly from the equipment that would be used to support the route, the techniques of the invention provide an optimal network design, and yield a configured network at the end of the process.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a block diagram illustrating an automated design system, according to an embodiment of the present invention;

FIGS. 2A and 2B are a flow diagram illustrating an automated design methodology, according to an embodiment of the present invention; and

FIG. 3 is a block diagram illustrating a generalized hardware architecture of a computer system suitable for implementing an automated design system, according to an embodiment of the present invention.

### DETAILED DESCRIPTION OF PREFERRED EMBODIMENTS

The following description will illustrate the invention in the context of an exemplary optical network. It should be understood, however, that the invention is not necessarily limited to use with any particular type of network. The invention is instead more generally applicable to any environment in which it is desirable to design an optimal network. Thus, by way of example only, the techniques of the invention may also be applied to wireless networks, Internet Protocol (IP) networks, etc. It is to be appreciated that the term “cost,” as used herein, is not intended to be limited only to monetary cost, but rather the term is intended to refer more generally to the expenditure of something for the attainment of a goal.

It is assumed that input to the design process is a set of nodes and a set of right-of-ways. Right-of-ways are links or edges where transmission equipment could potentially be deployed. Nodes relate to the geographic locations (e.g., cities) being connected by the links or edges. Equipment is deployed at the nodes as well. Examples of such equipment includes optical cross connects, digital cross connects, etc. Also, the input includes a set of traffic demands between different source-destination pairs. Each traffic demand has its own bandwidth requirement.

A conventional planning algorithm, such as the above-mentioned Spider algorithm, operates as follows, given the above inputs. The given set of demands are first ordered in a particular manner. For each demand, given the protection level associated therewith, i.e., protected or unprotected, the optimal routing algorithm to be used is chosen. It is known that protected demands have two paths provisioned at the time of their path setup, one called the primary path and the other called the backup path. These two paths are disjoint, in that they do not share any node or link in their path from their common source and destination. Traffic usually flows only on the primary path, and when there is a network failure of a node or link on the primary path, the source usually directs the traffic on the backup path. So, bandwidth is guaranteed on the backup path at the time of path setup for the traffic demand. Thus, the demand is called protected, since it is protected for failures. An unprotected demand is one which does not have a backup path. So, a network failure on its path will lead to traffic disruption, which is not good for critical traffic.

With the given routing algorithm, the cheapest path (using approximated dollar cost required to satisfy the given wavelength demand of a particular bandwidth) is chosen. Once all demands have been routed, for each demand in the given order, a demand is unrouted and re-routed again. This is done until the cost of the network does not improve. Since a routed demand depends on previously routed demands, it is known to unroute a demand and determine whether removal of the routed demand advantageously affects cost (i.e., lowers cost).

It is the step of routing a given demand with a given bandwidth and protection level that can be critical, and one process where the inventive design techniques provide a significant improvement over the conventional approach.

It is important for a routing algorithm to know the cost of routing a demand on a given link. The cost of deploying a wavelength of a given bandwidth on each link is, in reality, the cost of the required equipment that has to be deployed on the transmission system that is transporting the wavelengths on this link. A transmission system on a link (e.g., connecting two cities), in turn, has equipment such as amplifiers and regenerators placed at intermediate points. Since the wavelength will flow through all these intermediate points, additional equipment (such as circuit packs, line cards, etc.) may have to be added to support the transmission of this wavelength.

Thus, the present invention realizes that a proper way of routing the demand and finding the dollar cheapest path is to find the cost (exact or substantially exact) of the equipment needed to transport the given wavelength on the link. Further, this cost of equipment to support the wavelength also depends on the wavelengths already flowing on this link. Thus, at the end of routing all the demands, the inventive design techniques not only find the optimal path for each demand, but also yield the exact equipment that is needed on each link and node of the network.

As mentioned above, routing a particular demand greatly influences the way further demands are routed and the paths that they take. Thus, by using approximate costs (as is conventionally done) while routing may mean one is routing demands in a sub-optimal way (i.e., not the cheapest path).

A simple example of such a problem associated with this approximation approach is as follows. If a link has no wavelengths currently flowing thereon, in order to support just the first wavelength, the link would incur a huge startup cost to deploy amplifiers at all intermediate points. However, to support the second wavelength, only additional line cards may need to be added at each intermediate point, and hence is much cheaper. The approximation approach of conventional design systems would not take into account such a huge startup cost, and thus the actual cost of the route chosen would be greatly underestimated.

Thus, the invention realizes that routing demands using the exact cost required to support the wavelengths is highly advantageous. This is what the invention is able to accomplish by integrating the planning step and the configuration step of the design process. In addition, as a result of the process of the invention, a configured network is obtained. In the conventional approach, not only are the costs approximate, but the network still has to be configured once the demands have all been routed. As illustrated with the example above, this cost may turn out to be much different than what was computed during the routing step which had assumed an approximate cost model.

Given the above explanation of principles of the invention, an illustrative design system and methodology embodying such principles will now be described in the context of the figures.

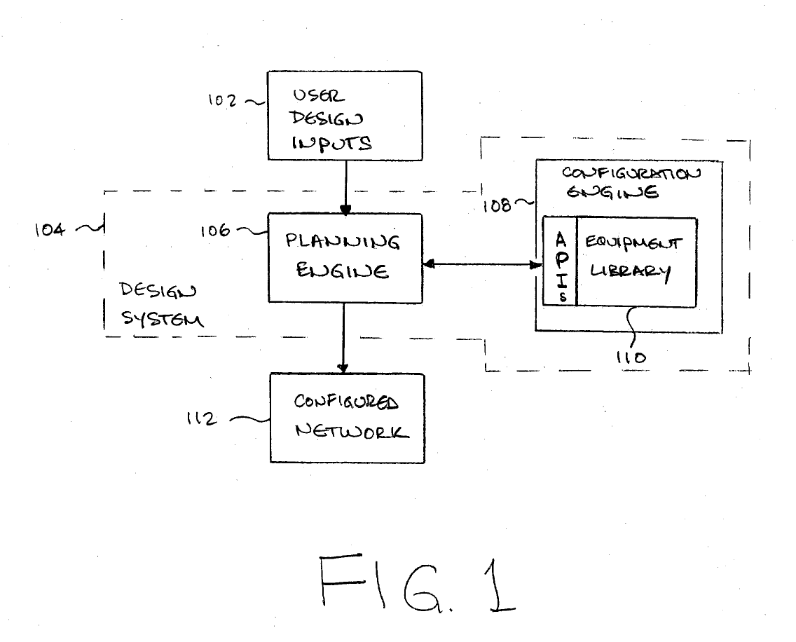

Referring initially to FIG. 1, a block diagram illustrates an automated design system, according to an embodiment of the present invention. As shown, design inputs 102 are provided by a user to design system 104 which, itself, comprises a planning engine 106 and a configuration engine 108. Configuration engine 108, itself, is shown as functionally comprising an equipment library 110, however, all or portions of the equipment library may be separate from configuration engine 108. The inputs to the design system may comprise a set of nodes and a set of links (the nodes and links representing an initial topology), as well as a set of traffic demands.

Design system 104 then computes a configured network 112 by determining one or more routes for the one or more traffic demands while querying at least a portion of the network equipment to determine a cost for using such equipment to route the one or more traffic demands such that the cost is considered when determining the one or more routes. Thus, as will be further explained below, the planning engine 106 and the configuration engine 108 integrally operate so as to determine the exact (or at least substantially exact) cost associated with network equipment to be used to route the demands.

For each node (e.g., representing a city) and each link (e.g., connecting two cities), design system 104 determines the cost of equipment that is needed to support the traffic demand. In order to accomplish this, in a preferred embodiment, each piece of equipment may implement one or more application programming interfaces (APIs). The piece of equipment, in response to being queried, provides the optimal cost of supporting the given set of demands. Thus, for example on each link, planning engine 106 queries each piece of equipment in the equipment library 110, associated with configuration engine 108, that can support the given set of demands and the associated cost for the same. If the link already has preconfigured equipment with some spare capacity, the planning engine 106 queries the preconfigured equipment to return the cost of supporting the additional set of demands.

It is to be appreciated that one of ordinary skill in the art would be able to design such APIs to implement such a standardized query/response interface. Nonetheless, by way of example only, a type of query/response supported by such an interface may be as follows. A query may be made to obtain the cost for supporting ten OC48 wavelengths (2.5 gigabits) on the given link, and a query may be made to obtain the cost of supporting fifteen OC48 wavelengths and twenty OC192 wavelengths on the link. In the first query, the cost of the ten OC48 wavelengths is returned. In the second query, the cost of the fifteen OC48 wavelengths and the twenty OC192 wavelengths is returned. Also, additional cost (if applicable) required to support these wavelengths is added and returned back in the response to the queries. In the second query, for example, this could be the cost of including dispersion compensation modules at each amplifier along the link, which are required to compensate the non-linearities of OC192 wavelengths and are many times not required for OC48 wavelengths. In the case of nodes, the query may request the cost of supporting ten OC192 wavelengths on the given node. The reply then includes the cost of the required number of ports to support the wavelengths and also, if appropriate, the cost of a new switch size for the node (e.g, if a larger switch size is required in the optical cross connect at that node due to the addition of these wavelengths).

Accordingly, the interaction of the planning engine 106 and the configuration engine 108 is through a fixed set of APIs which each piece of equipment in the equipment library 110 preferably implements. The APIs could also be implemented remote from (but coupled to) the equipment.

Linking planning engine 106 and configuration engine 108 through fixed interfaces (APIs) has the additional advantage of design system 104 being able to support third-party equipment libraries. Thus, users may plug-in a new set of equipment with their own rules for configuration and implement the APIs defined in the equipment interface. This way, design system 104 can configure a network with any set of equipment. Advantageously, by defining standard APIs and publishing them to the design community, network designers are able to utilize these APIs for such third-party equipment and plug-in the equipment so as to realize the advantages of planning a multi-vendor network and of sophisticated network design and routing algorithms.

On the equipment manufacturer side, an equipment manufacturer need only implement the APIs on its equipment so that the equipment can respond to the design system when queried. In this way, operational details (possibly proprietary in nature) of the equipment need not be revealed to the design system, rather only a response to the query (e.g., what is cost to implement these particular wavelengths on this piece of equipment) need be provided. Thus, the equipment is adapted by the manufacturer to support the standard queries coming from the design system such that an appropriate response may be provided. Further, it is to be understood that not every single piece of equipment in the optical network needs to support such standardized query/response interface (although, this could be the case). That is, it may be that only equipment tasked with transmitting wavelengths in accordance with links and nodes needs to support the fixed interface.

Also, with multiple equipment systems that can be deployed on a given link to support the same set of demands, using standard APIs during the design process helps the design algorithm to choose the cheapest among the equipment suitable for supporting the given set of demands on this link.

While the APIs supported by the network equipment are referred to as being standard or fixed for all equipment, it is understood that the APIs may be substantially standard or fixed since they may have differences based on the particular piece of equipment with which they are implemented (e.g., a piece of equipment may have a characteristic or feature that another piece of equipment may not have, thus the APIs implemented by each piece of equipment may reflect that difference).

Thus, as is evident, the integration of the configuration process with the planning process, according to the invention, enables a designer (user) to obtain configured networks at the end of the process and leads to a good optimal design.

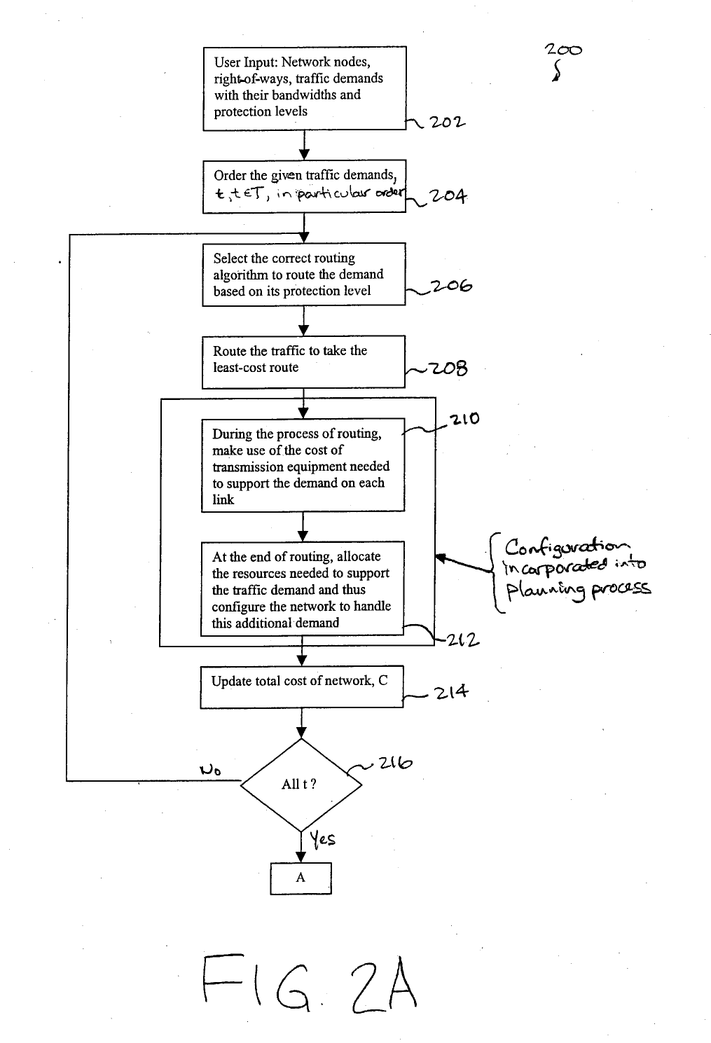

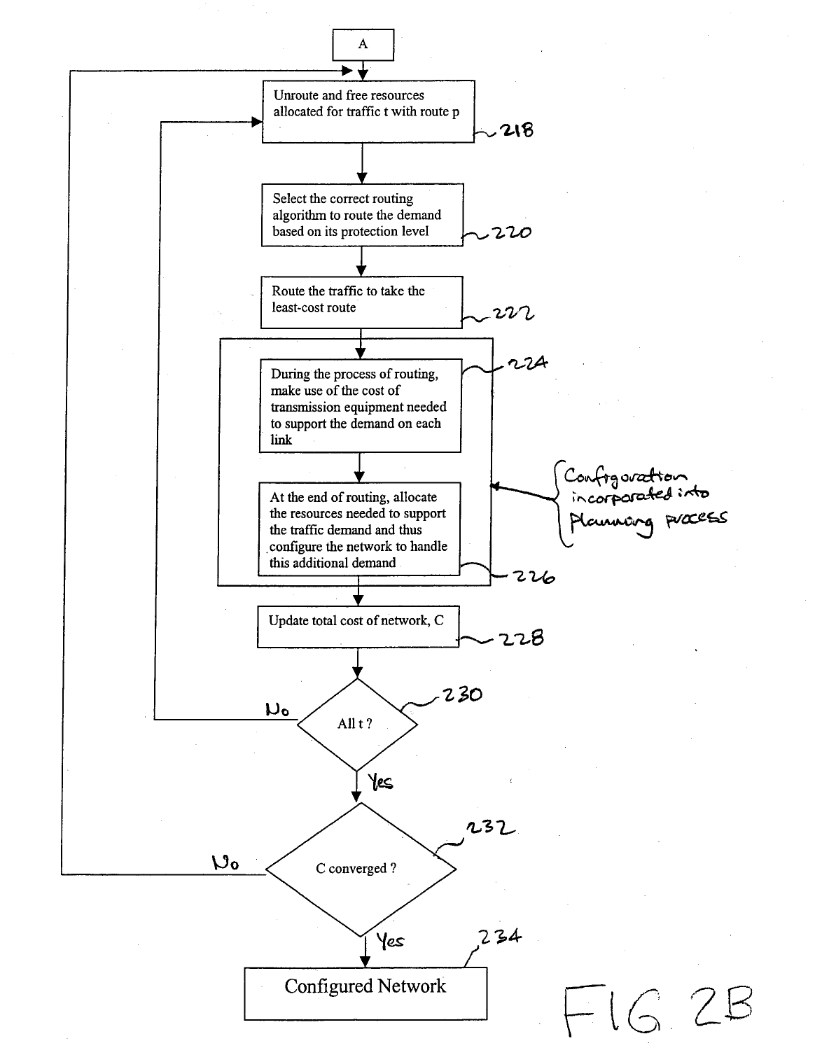

Referring now to FIGS. 2A and 2B, a flow diagram illustrates an automated design methodology, according to an embodiment of the present invention. It is to be appreciated that methodology 200 shown in FIGS. 2A and 2B may be implemented, for example, by planning engine 106 and configuration engine 108 of design system 104 of FIG. 1. While methodology 200 shows the design process for equipment to be associated with links in the optical network, it is to be understood that similar steps may be performed to determine equipment to be associated with nodes in the optical network.

In step 202, the user design input is obtained. As mentioned, this comprises network nodes, right-of-ways, and traffic demands with their bandwidths and protection levels. In step 204, the traffic demands (each traffic demand referred to as t, where t ε T) are ordered into a particular order.

For each demand, given the protection level associated therewith (i.e., protected or unprotected), the optimal routing algorithm to be used is selected in step 206. With the given routing algorithm, the least-cost route is determined in step 208. It is to be appreciated that the determination of the optimal routing algorithm and the least-cost route may be made using techniques well known to those skilled in the art. By way of example, but not intended to limit the invention, the Dijkstra shortest (cheapest) path algorithm (see T. Cormen et al., “Introduction to Algorithms,” MIT Press, Cambridge, Mass., 1990) may be used to route unprotected traffic demands, and the Suurbaale algorithm (see J. W. Suurbaale, “Disjoint Paths in a Network,” Networks, June 1974) may be used to route protected traffic demands based on the shortest (cheapest) cycle.

Then, in accordance with the present invention, configuration steps are incorporated into the planning process. This is done in steps 210 and 212.

More specifically, in step 210, the transmission equipment needed to support the demand on each link is queried to obtain the cost to be incurred for using the equipment to support the demand. This is done in accordance with the APIs described above. This cost is then used in the routing process.

In step 212, at the end of routing, the resources needed to support the traffic demand are allocated, and thus the network is configured to handle this demand. Allocation of resources may include keeping track of the current equipment configured on each link. For example, if previously a few OC192 demands had been routed (and thus configured) on this link, then equipment required to support these OC192 wavelengths will already have been accounted for in the cost of configuration. One such type of equipment includes dispersion compensation modules required to support the OC192 wavelengths. So, if new additional OC192 wavelengths are to be routed on this link, the design system does not need to add the dispersion compensation modules as they have already been configured on each of the nodes. Thus, resource allocation mainly keeps track of the equipment currently configured on each intermediate node on the link and uses this information while routing and configuring new demands. Similarly, during unrouting of demands and freeing resources, the design system would unallocate the dispersion compensation modules only when all the OC 192 wavelengths on this link have been removed.

In step 214, the total cost C of the network is updated.

Steps 206 through 214 are repeated for each demand until all demands have been routed, as determined at step 216.

Once all demands have been routed, for each demand in the given order, a demand is unrouted and re-routed again. This is done until the cost of the network does not improve. So, in step 218, the methodology unroutes and frees resources allocated for traffic t with route p. In step 220, the correct routing algorithm is selected to route the demand based on its protection level. In step 222, the methodology routes the traffic to take the least-cost route. In steps 224 and 226, the invention incorporates configuration steps into the planning process. Again, this is done by querying the equipment to get the exact cost associated with using the queried equipment to support the routed demand, and allocating the resources needed to support the demand. The total cost C of the network is updated in step 228.

The unrouting and rerouting of steps 218 through 228 is repeated for each demand until all demands have been processed, as determined at step 230.

In step 232, it is determined whether the total cost C of the network has converged (e.g., no longer improves). If no, the unrouting and rerouting steps may be continued with different combinations of routes being unrouted and rerouted. If the total cost C has converged, then the design process is complete and the configured network is output in step 234. By configured network, it is meant a specification of the topology and the equipment that will be used to realize the network. Specification of the topology and equipment may take any one of a variety of forms known to those skilled in the art.

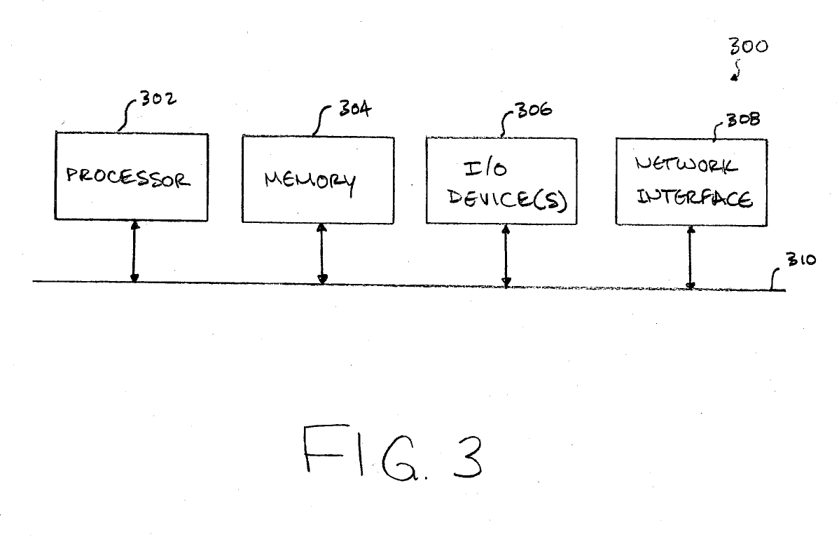

Referring now to FIG. 3, a block diagram illustrates a generalized hardware architecture of a computer system suitable for implementing an automated design system, according to an embodiment of the present invention. More particularly, all or parts of design system 104 of FIG. 1 (namely, planning engine 106 and configuration engine 108) may implement such a computing system 300 to perform the techniques of the invention. Of course, it is to be understood that the invention is not limited to any particular computing system implementation. With respect to configuration engine 108 of FIG. 1, it is to be understood that all or parts of the configuration engine may be implemented on the computing system. The APIs are preferably supported by the configuration engine and implemented on each piece of equipment. In which case, the part of the configuration engine 108 implemented on the computing system would serve as a mechanism for accessing the equipment APIs (e.g., passing queries from the planning engine to the equipment), introducing new equipment specifications, taking actions to allocate equipment to support a set of demands, etc.

In this illustrative implementation, a processor 302 for implementing at least a portion of the methodologies of the invention is operatively coupled to a memory 304, input/output (I/O) device(s) 306 and a network interface 308 via a bus 310, or an alternative connection arrangement. It is to be appreciated that the term “processor” as used herein is intended to include any processing device, such as, for example, one that includes a central processing unit (CPU) and/or other processing circuitry (e.g., digital signal processor (DSP), microprocessor, etc.). Additionally, it is to be understood that the term “processor” may refer to more than one processing device, and that various elements associated with a processing device may be shared by other processing devices.

The term “memory” as used herein is intended to include memory and other computer-readable media associated with a processor or CPU, such as, for example, random access memory (RAM), read only memory (ROM), fixed storage media (e.g., hard drive), removable storage media (e.g., diskette), flash memory, etc.

In addition, the phrase “I/O devices” as used herein is intended to include one or more input devices (e.g., keyboard, mouse, etc.) for inputting data to the processing unit, as well as one or more output devices (e.g., CRT display, etc.) for providing results associated with the processing unit. It is to be appreciated that such input devices may be one mechanism for a user to provide the design inputs (e.g., 102 in FIG. 1) used by a design system (e.g., 104 in FIG. 1) to generate a configured network (e.g., 112 in FIG. 1). Alternatively, the design inputs could be read into the design system from a diskette or from some other source (e.g., another computer system) connected to the computer bus 310. The output devices may be one mechanism for a user to be presented with a specification of the configured network. Also, the I/O devices may be used to add new equipment specifications and access APIs.

Still further, the phrase “network interface” as used herein is intended to include, for example, one or more devices capable of allowing the computing system 300 to communicate with network equipment (e.g., all or part of the equipment library 110). Thus, the network interface may comprise a transceiver configured to communicate with a transceiver of piece of network equipment via a suitable communications protocol. It is to be understood that since the communications protocols employed may be specific to the types of network equipment, the invention is not limited to any particular communications protocol.

It is to be appreciated that while the present invention has been described herein in the context of an automated design system, the methodologies of the present invention may be capable of being distributed in the form of computer readable media, and that the present invention may be implemented, and its advantages realized, regardless of the particular type of signal-bearing media actually used for distribution. The term “computer readable media” as used herein is intended to include recordable-type media, such as, for example, a floppy disk, a hard disk drive, RAM, compact disk (CD) ROM, etc., and transmission-type media, such as digital and analog communication links, wired or wireless communication links using transmission forms, such as, for example, radio frequency and optical transmissions, etc. The computer readable media may take the form of coded formats that are decoded for use in a particular data processing system.

Accordingly, one or more computer programs, or software components thereof, including instructions or code for performing the methodologies of the invention, as described herein, may be stored in one or more of the associated storage media (e.g., ROM, fixed or removable storage) and, when ready to be utilized, loaded in whole or in part (e.g., into RAM) and executed by the processor 302.

In any case, it is to be appreciated that the techniques of the invention, described herein and shown in the appended figures, may be implemented in various forms of hardware, software, or combinations thereof, e.g., one or more operatively programmed general purpose digital computers with associated memory, implementation-specific integrated circuit(s), functional circuitry, etc. Given the techniques of the invention provided herein, one of ordinary skill in the art will be able to contemplate other implementations of the techniques of the invention.

It is to be appreciated that the design system of the invention may also implement the design methodologies described in the U.S. patent application identified as attorney docket no. Alicherry 4-3-4-4-19, entitled “Network Design Utilizing Network Management Routing Algorithm,” filed concurrently herewith and commonly assigned, the disclosure of which is incorporated by reference herein.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

We claim:

1. An automated method of designing a network, the method comprising the steps of:
obtaining a set of nodes and a set of links with which network equipment may be deployed, and one or more traffic demands; and
computing a network, the network being computed by determining one or more routes for the one or more traffic demands while querying at least a portion of the network equipment to determine a cost for using said equipment to route the one or more traffic demands such that said cost is considered when determining the one or more routes.

2. The method of claim 1, wherein said network equipment is queried via at least one application programming interface.

3. The method of claim 2, wherein the at least one application programming interface is substantially standard across the network equipment.

4. The method of claim 1, wherein the network equipment to be queried is part of an equipment library.

5. The method of claim 4, further comprising the step of adding a new piece of equipment to the equipment library, wherein the new piece of equipment may be queried upon addition for consideration during the computation step.

6. The method of claim 1, wherein the computation step further comprises allocating network equipment based on the route determination such that the computed network comprises a configured network.

7. The method of claim 1, wherein the set of traffic demands comprises at least one of protected demands and unprotected demands.

8. The method of claim 1, wherein the network being designed is an optical network.

9. Apparatus for designing a network, the apparatus comprising:
a memory; and
at least one processor coupled to the memory and operative to: (i) obtain a set of nodes and a set of links with which network equipment may be deployed, and one or more traffic demands; and (ii) compute a network, the network being computed by determining one or more routes for the one or more traffic demands while querying at least a portion of the network equipment to determine a cost for using said equipment to route the one or more traffic demands such that said cost is considered when determining the one or more routes.

10. The apparatus of claim 9, wherein said network equipment is queried via at least one application programming interface.

11. The apparatus of claim 10, wherein the at least one application programming interface is substantially standard across the network equipment.

12. The apparatus of claim 9, wherein the network equipment to be queried is part of an equipment library.

13. The apparatus of claim 12, wherein the at least one processor is further operative to permit addition of a new piece of equipment to the equipment library, wherein the new piece of equipment may be queried upon addition for consideration during the computation operation.

14. The apparatus of claim 9, wherein the computation operation further comprises allocating network equipment based on the route determination such that the computed network comprises a configured network.

15. The apparatus of claim 9, wherein the set of traffic demands comprises at least one of protected demands and unprotected demands.

16. Apparatus for designing a network, the apparatus comprising:
a network planning engine; and
a network configuration engine, the network configuration engine being coupled to the network planning engine and having network equipment associated therewith;
wherein the network planning engine obtains a set of nodes and a set of links with which network equipment may be deployed, and one or more traffic demands, and wherein the network planning engine computes a network, the network being computed by determining one or more routes for the one or more traffic demands while querying at least a portion of the network equipment via the network configuration engine to determine a cost for using said equipment to route the one or more traffic demands such that said cost is considered when determining the one or more routes.
